(19) United States
(12) Patent Application Publication
(10) Pub. No.: US 2026/0288194 A1
(43) Pub. Date: Sep. 24, 2026

(54) MICROWAVE PULSE GENERATOR, QUANTUM COMPUTER, AND MICROWAVE PULSE GENERATION METHOD

(71) Applicant: Hitachi, Ltd., Tokyo (JP)

(72) Inventors: Takayasu NORIMATSU, Tokyo (JP); Yusuke Wachi, Tokyo (JP)

(21) Appl. No.: 19/532,059

(22) Filed: Feb. 6, 2026

(30) Foreign Application Priority Data
Mar. 21, 2025 (JP) 2025-047547

(51) Int. Cl. G06F 1/06

(52) U.S. Cl. CPC G06F 1/06

(57) ABSTRACT

Both high-speed ON/OFF control of an output circuit and maximization of the number of quantum bit operations within an operation time are achieved in a microwave pulse generator. A plurality of divided microwave pulses are output based on divided amplitude signals and clock signals, and a single microwave pulse obtained by adding the divided microwave pulses is output.

### BACKGROUND OF THE INVENTION

### Field of the Invention

The present invention relates to a microwave pulse generator, a quantum computer, and a microwave pulse generation method.

### Description of the Related Art

The limits of semiconductor miniaturization become apparent, and the approach of improving von Neumann computers through semiconductor miniaturization is nearing its limit. Therefore, increasing attention is being paid to computers that can operate on principles different from those of the von Neumann type and can solve specific problems at a high speed. Among them, quantum computers are being actively developed.

The quantum computer performs computations by operating quantum state probabilities, using energy states of devices known as quantum bits, which can exist in superpositions, and the like as information. Examples of the quantum bits include quantum bits based on superconductivity and quantum bits based on electron spin. In the case of the electron spin, two orientations of electron spin are used as information.

When a strong magnetic field is applied to an electron from the outside, the energy levels of two states, that is, a spin-up state and a spin-down state, are different from each other. At this time, the spin angular frequency of the electron changes depending on the strength of the magnetic field. During the coherence time, the electron exists in a superposition of the spin-up state and the spin-down state, and a radio frequency (RF) magnetic field with the same frequency as the angular frequency of the electron can be applied to operate the probabilities of the two spin states.

When the RF magnetic field is applied, the probabilities of the two spin states undergo Rabi oscillations that change sinusoidally depending on the applied energy. Therefore, it is necessary to apply the RF magnetic field as a pulse in order to operate the spin state probabilities to the required level. Hereafter, the pulse of the RF magnetic field is referred to as a microwave pulse.

In order to perform computations and error correction in the quantum computer, it is necessary to perform various types of control and signal readouts within a period of time that is sufficiently shorter than the coherence time. Among control operations, only some control operations require microwave pulses. When the microwave pulses are not required, they can act as noise. Therefore, in this case, it is necessary to turn off a microwave pulse generation circuit.

It is necessary to perform the ON/OFF control of the coherence time and the microwave pulse generation circuit on the order of nanoseconds. In addition, it is necessary to operate quantum bits in a short time and to multiplex the microwave pulses. Therefore, it is necessary to achieve both ON/OFF control in the order of nanoseconds and the generation of multiplexed microwave pulses in the microwave pulse generator.

The microwave pulse generator that generates the RF magnetic field through irradiation with microwave pulses uses an IQ modulator to enable phase control (see US2018/0013426, US2020/0034736, and J. Park and et. al., "A Fully Integrated Cryo-CMOS SoC for State Manipulation, Readout, and High-Speed Gate Pulsing of Spin Qubits," IEEE JSSC, Vol. 56, No. 11, November 2021.).

The IQ modulator is a device that is commonly used in a communication device and can generate frequency-multiplexed microwave pulses. However, blocks that generate high-frequency signals, such as a driver and a mixer, in the IQ modulator are operated based on a predetermined bias voltage, and the bias voltage needs to be set to 0 V in order to completely turn off the outputs from these blocks, including the leakage of an LO signal. When the bias voltage is switched between the predetermined voltage and 0 V at a high speed, a signal, to which a switching signal has been added, is output. As a result, it is not possible to perform the switching at a high speed, and a switching time of several tens of nanoseconds is required. Therefore, a general IQ modulator can generate frequency-multiplexed signals, but high-speed ON/OFF control remains a technical challenge.

Examples of the microwave pulse generator that enables high-speed ON/OFF control of the high-frequency output circuit include a microwave pulse generator using polar modulation (see Japanese Patent Application Publication No. 2024-163701) and a pulse generator for Ultra-Wide Band (UWB) applications (see E. Allebes and et. al., "A 3-to-10 GHz 180 pJ/b IEEE802.15.4z/4a IR-UWB Coherent Polar Transmitter in 28-nm CMOS with A Synchronous Amplitude Pulse-Shaping and Injection-Locked Phase Modulation," IEEE ISSCC2021, pp. 304-305, September 2021.).

This circuit has a plurality of digital-to-analog converters (DACs), and clock gating is performed on DACs with a data signal input of 0 to completely turn off each DAC. Therefore, it is possible to turn on and off the circuit according to a sampling rate of a data signal and to turn on and off the circuit on the order of nanoseconds. However, since the DAC can only operate at a single frequency, it is not possible to perform frequency multiplexing and thus to generate multiplexed microwave pulses.

In the quantum computers using electron spin, a challenge for the microwave pulse generator that performs quantum operations is to achieve both ON/OFF control of the output circuit on the order of nanoseconds and maximization of the number of quantum bit operations within the operation time.

### SUMMARY OF THE INVENTION

An object of the present invention is to achieve both high-speed ON/OFF control of an output circuit and maximization of the number of quantum bit operations within an operation time in a microwave pulse generator.

According to an aspect of the present invention, there is provided a microwave pulse generator including: a plurality of modulators; an adder adding output signals of the plurality of modulators; an oscillator generating a plurality of clock signals with different frequencies; a clock switch that switches between the plurality of clock signals based on a clock switching signal and assigns different clock signals to the plurality of modulators at different timings; and a pulse signal switch that divides a pulse waveform setting signal into a plurality of amplitude signals based on a pulse switching signal and assigns the divided amplitude signals to the plurality of modulators at different timings, respectively. The plurality of modulators output a plurality of divided microwave pulses based on the divided amplitude signals and the clock signals, and the adder adds the divided microwave pulses output from the plurality of modulators and outputs a single microwave pulse.

According to an aspect of the present invention, it is possible to achieve both the high-speed ON/OFF control of the output circuit and the maximization of the number of quantum bit operations within the operation time in the microwave pulse generator.

### BRIEF DESCRIPTION OF THE DRAWINGS

FIG. 1 is a diagram showing an example of a configuration of a quantum computer;

FIG. 2 is a diagram showing a microwave pulse generator according to Embodiment 1;

FIG. 3 is a diagram showing input and output waveforms of a pulse waveform switch in the microwave pulse generator according to Embodiment 1;

FIG. 4 is a diagram showing input and output waveforms of a clock switch in the microwave pulse generator according to Embodiment 1;

FIG. 5 is a diagram showing input and output waveforms of a high-frequency digital-to-analog converter (DAC) in the microwave pulse generator according to Embodiment 1;

FIG. 6 is a diagram showing an example of a circuit of the high-frequency DAC in the microwave pulse generator according to Embodiment 1;

FIG. 7 is a diagram showing an example of a clock gating circuit in the high-frequency DAC in the microwave pulse generator according to Embodiment 1;

FIG. 8 is a diagram showing an example of a drive circuit in the high-frequency DAC in the microwave pulse generator according to Embodiment 1;

FIG. 9 is a diagram showing an example of a configuration of a quantum computer using a microwave pulse generator according to Embodiment 2;

FIG. 10 is a diagram showing the microwave pulse generator according to Embodiment 2;

FIG. 11 is a diagram showing input and output waveforms of a pulse waveform switch in the microwave pulse generator according to Embodiment 2;

FIG. 12 is a diagram showing input and output waveforms of a high-frequency DAC in the microwave pulse generator according to Embodiment 2;

FIG. 13 is a diagram showing a microwave pulse generator according to Embodiment 3;

FIG. 14 is a diagram showing a microwave pulse generator according to Embodiment 4;

FIG. 15 is a diagram showing input and output waveforms of a pulse waveform switch in the microwave pulse generator according to Embodiment 4;

FIG. 16 is a diagram showing input and output waveforms of a clock switch in the microwave pulse generator according to Embodiment 4;

FIG. 17 is a diagram showing input and output waveforms of a high-frequency DAC in the microwave pulse generator according to Embodiment 4;

FIG. 18 is a diagram showing an example of a circuit of the high-frequency DAC in the microwave pulse generator according to Embodiment 4;

FIG. 19 is a diagram showing an example of a drive circuit in the high-frequency DAC in the microwave pulse generator according to Embodiment 4; and

FIG. 20 is a diagram showing an entire system including a quantum computing device according to Embodiment 5.

### DETAILED DESCRIPTION OF THE PREFERRED EMBODIMENTS

The present invention will be described in detail below with reference to the drawings.

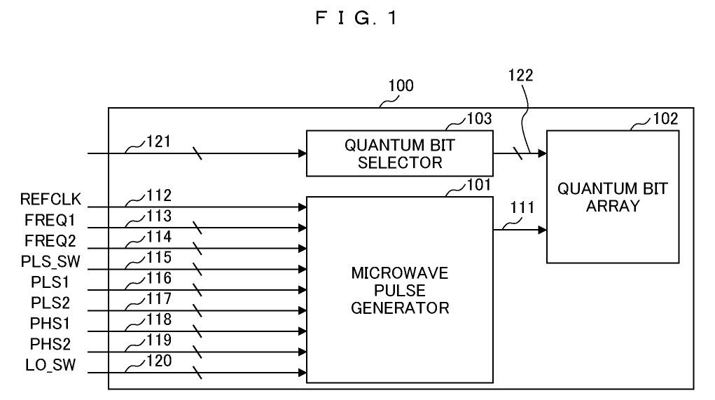

FIG. 1 shows peripheral blocks of a microwave pulse generator in a quantum computer.

A quantum computer 100 includes a quantum bit array 102 that holds information, a microwave pulse generator 101 that operates the quantum bit array 102, and a quantum bit selector 103 that selects a quantum bit to be operated from quantum bit array 102.

In the quantum bit array 102, quantum bits are disposed in an array, and the state of only the quantum bit selected by a quantum bit selection signal 122 is operated by irradiation with a microwave pulse 111. The quantum bit selector 103 receives a quantum bit address signal 121 and outputs the quantum bit selection signal 122 to select the quantum bit to be subjected to a quantum operation from the quantum bit array 102. In this case, the selection can be made by changing an angular frequency of the quantum bit to be selected.

A reference clock 112, a frequency setting signal A 113, a frequency setting signal A 114, a pulse switching signal 115, a pulse waveform setting signal A 116, a pulse waveform setting signal B 117, a phase setting signal A 118, a phase setting signal B 119, and a clock switching signal 120 are input to the microwave pulse generator 101.

Then, a clock having a frequency and a phase set by the frequency setting signal A 113 and the phase setting signal A 118, and a clock having a frequency and a phase set by the frequency setting signal B 114 and the phase setting signal B 119 are generated in the microwave pulse generator, and the microwave pulse becomes a signal having the center frequency and phase of one of the clocks according to the clock switching signal 120. Further, the pulse waveform setting signal A 116 and the pulse waveform setting signal B 117 are selected according to the pulse switching signal 118, and an envelope shape of the microwave pulse is set. Since the microwave pulse generator 101 generates clocks having a plurality of frequencies, microwave pulses having different center frequencies can be superimposed and output. In addition, in this embodiment, two types of frequency settings and pulse settings are given as an example for simplicity. However, the same approach can be extended to three, four, or more types of frequency settings and pulse settings.

### Embodiment 1

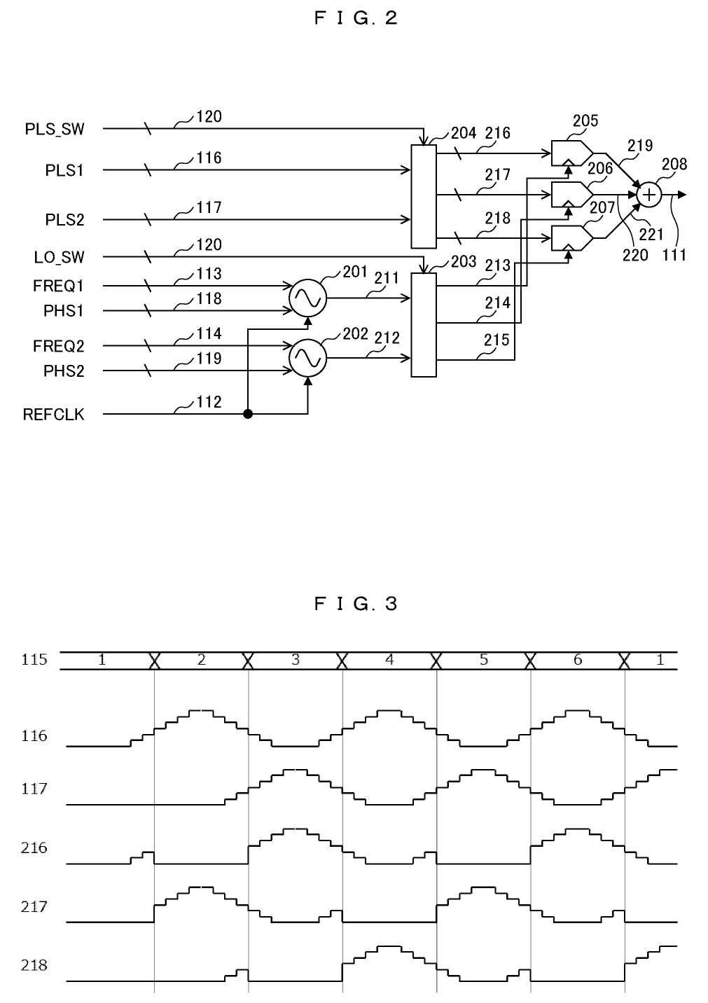

FIG. 2 shows Embodiment 1 of the microwave pulse generator 101.

The microwave pulse generator 101 includes a frequency generator A 201, a frequency generator B 202, a clock switch 203, a pulse signal switch 204, a high-frequency DAC_A 205, a high-frequency DAC_B 206, a high-frequency DAC_C 207, and an adder 208. Phase locked loops (PLLs) are assumed as the frequency generator A 201 and the frequency generator B202. The frequency generator A 201 multiplies the reference clock 112 to generate a clock 211 having the frequency and phase set by the frequency setting signal A 113 and the phase setting signal A 118, and the frequency generator B202 multiplies the reference clock 112 to generate a clock 212 having the frequency and phase set by the frequency setting signal A 114 and the phase setting signal A 119.

The clock switch 203 receives the clock 211 and the clock 212 and switches between the clock 211 and the clock 212 such that one of the clock 211 and the clock 212 is output to a high-frequency DAC_A clock 213, a high-frequency DAC_B clock 214, and a high-frequency DAC_C clock 215 in response to the clock switching signal 120. The pulse signal switch 204 receives the pulse waveform setting signal A 116 and the pulse waveform setting signal B 117 and switches between the pulse waveform setting signal A 116 and the pulse waveform setting signal B 117 such that one of the pulse waveform setting signal A 116 and the pulse waveform setting signal B 117 is output to high-frequency DAC_A data 216, high-frequency DAC_B data 217, and high-frequency DAC_C data 218 in response to the pulse switching signal 115. The high-frequency DAC_A 205 receives the high-frequency DAC_A clock 213 and the high-frequency DAC_A data 216 and outputs a microwave pulse 219 that has the high-frequency DAC_A data 216 as an amplitude and the frequency of the high-frequency DAC_A clock 213 as a center frequency.

Similarly, the high-frequency DAC_B 206 receives the high-frequency DAC_B clock 214 and the high-frequency DAC_B data 217 and outputs a microwave pulse 220 that has the high-frequency DAC_B data 217 as an amplitude and the frequency of the high-frequency DAC_B clock 214 as a center frequency. Similarly, the high-frequency DAC_C 207 receives the high-frequency DAC_C clock 215 and the high-frequency DAC_C data 218 and outputs a microwave pulse 221 that has the high-frequency DAC_C data 218 as an amplitude and the frequency of the high-frequency DAC_C clock 215 as a center frequency. The adder 208 adds the microwave pulse 219, the microwave pulse 220, and the microwave pulse 221 together to generate a microwave pulse 111.

FIG. 3 shows the input and output of the pulse signal switch 204 among the signal waveforms according to the embodiment shown in FIG. 2.

FIG. 3 shows an example in which the pulse waveform setting signal A 116 and the pulse waveform setting signal B 117 partially overlap with each other. However, the overlapping manner and the number of pulse waveform setting signals can be changed depending on the number of parallel DACs and the like. In the example shown in FIG. 3, when the pulse switching signal 115 is 1, the pulse waveform setting signal A 116 is output to the high-frequency DAC_A data 216, 0 is output to the high-frequency DAC_B data 217, and the pulse waveform setting signal B 117 is output to the high-frequency DAC_C data 218.

When the pulse switching signal 115 is 2, 0 is output to the high-frequency DAC_A data 216, the pulse waveform setting signal A 116 is output to the high-frequency DAC_B data 217, and the pulse waveform setting signal B 117 is output to the high-frequency DAC_C data 218. When the pulse switching signal 115 is 3, the pulse waveform setting signal B 117 is output to the high-frequency DAC_A data 216, the pulse waveform setting signal A 116 is output to the high-frequency DAC_B data 217, and 0 is output to the high-frequency DAC_C data 218. When the pulse switching signal 115 is 4, the pulse waveform setting signal B 117 is output to the high-frequency DAC_A data 216, 0 is output to the high-frequency DAC_B data 217, and the pulse waveform setting signal A 116 is output to the high-frequency DAC_C data 218.

When the pulse switching signal 115 is 5, 0 is output to the high-frequency DAC_A data 216, the pulse waveform setting signal B 117 is output to the high-frequency DAC_B data 217, and the pulse waveform setting signal A 116 is output to the high-frequency DAC_C data 218. When the pulse switching signal 115 is 6, the pulse waveform setting signal A 116 is output to the high-frequency DAC_A data 216, the pulse waveform setting signal B 117 is output to the high-frequency DAC_B data 217, and 0 is output to the high-frequency DAC_C data 218. As described above, of the pulse waveform setting signal A 116 and the pulse waveform setting signal B 117, the same pulse waveform setting signal is output twice to each of the high-frequency DAC_A data 216, the high-frequency DAC_B data 217, and the high-frequency DAC_C data 218, and then 0 is output thereto. Then, the pulse waveform setting signal is switched to the other signal.

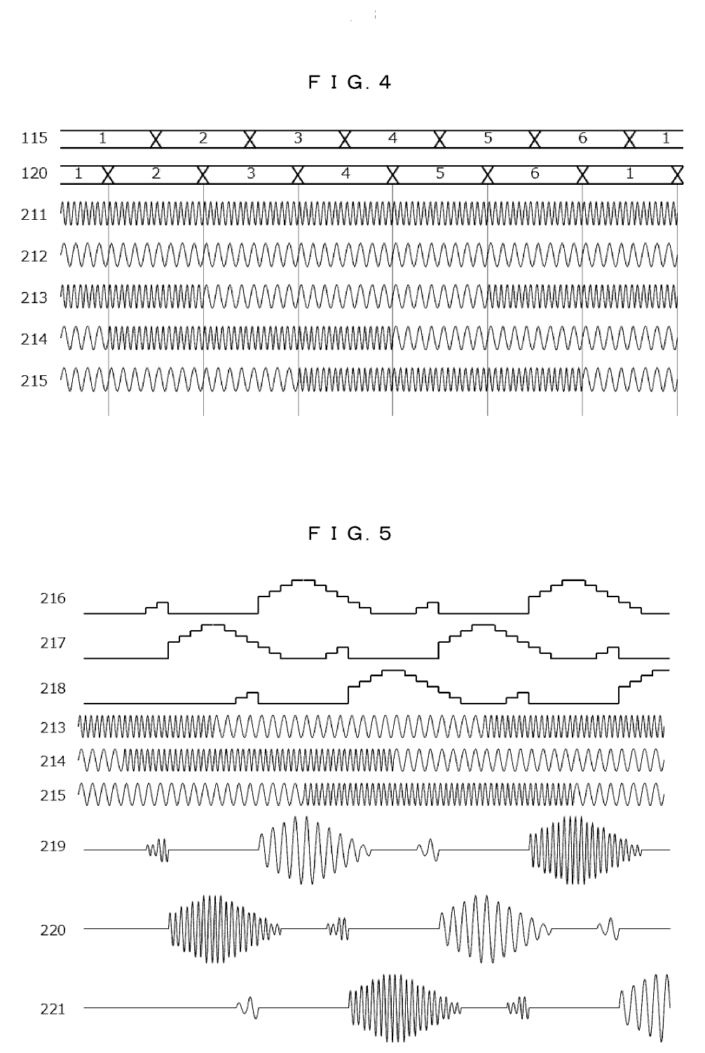

FIG. 4 shows the input and output of the clock switch 203 among the signal waveforms according to the embodiment shown in FIG. 2.

The clock switching signal 120 is switched during the period for which the pulse switching signal 115 is constant, and the clock to be input to the DAC to which data input is 0 among the high-frequency DAC among the high-frequency DAC_A 205, the high-frequency DAC_B 206, and the high-frequency DAC_C 207 is switched. Since degradation of clock characteristics, such as a reduction in amplitude, is considered during switching, clock switching is performed on the DAC to which the input data is 0 and which outputs 0. In this way, when the clock switching signal 120 is 1, the clock 211 is output to the high-frequency DAC_A clock 213, the clock 212 is output to the high-frequency DAC_B clock 214, and the clock 212 is output to the high-frequency DAC_C clock 215.

Similarly, when the clock switching signal 120 is 2, the clock 211 is output to the high-frequency DAC_A clock 213, the clock 211 is output to the high-frequency DAC_B clock 214, and the clock 212 is output to the high-frequency DAC_C clock 215. When the clock switching signal 120 is 3, the clock 212 is output to the high-frequency DAC_A clock 213, the clock 211 is output to the high-frequency DAC_B clock 214, and the clock 212 is output to the high-frequency DAC_C clock 215.

When the clock switching signal 120 is 4, the clock 212 is output to the high-frequency DAC_A clock 213, the clock 211 is output to the high-frequency DAC_B clock 214, and the clock 211 is output to the high-frequency DAC_C clock 215. When the clock switching signal 120 is 5, the clock 212 is output to the high-frequency DAC_A clock 213, the clock 212 is output to the high-frequency DAC_B clock 214, and the clock 211 is output to the high-frequency DAC_C clock 215. When the clock switching signal 120 is 6, the clock 211 is output to the high-frequency DAC_A clock 213, the clock 212 is output to the high-frequency DAC_B clock 214, and the clock 211 is output to the high-frequency DAC_C clock 215.

FIG. 5 shows the input and output of the high-frequency DAC_A 205, the high-frequency DAC_B 206, and the high-frequency DAC_C 207 among the signal waveforms according to the embodiment shown in FIG. 2.

The high-frequency DAC_A 205 generates the microwave pulse 219 that has the high-frequency DAC_A data 216 as an envelope and has the same frequency as the high-frequency DAC_A clock 213. The high-frequency DAC_B 206 generates the microwave pulse 220 that has the high-frequency DAC_B data 217 as an envelope and has the same frequency as the high-frequency DAC_B clock 214. The high-frequency DAC_C 207 generates the microwave pulse 221 that has the high-frequency DAC_C data 218 as an envelope and has the same frequency as the high-frequency DAC_C clock 215.

The high-frequency DAC_A data 216, the high-frequency DAC_B data 217, the high-frequency DAC_C data 218, the high-frequency DAC_A clock 213, the high-frequency DAC_B clock 214, and the high-frequency DAC_C clock 215 are switched over time, resulting in changes in the microwave pulse 219, the microwave pulse 220, and the microwave pulse 221. The microwave pulse 111, which is the output of the microwave pulse generator 101, has the waveform obtained by adding the microwave pulse 219, the microwave pulse 220, and the microwave pulse 221 together using the adder 208.

The microwave pulse generator 101 according to Embodiment 1 includes a plurality of modulators (205, 206, 207), the adder 208 that adds output signals of the plurality of modulators (205, 206, 207), oscillators (201, 202) that generate a plurality of clock signals (211, 212) having different frequencies, the clock switch 203 that switches between the plurality of clock signals (211, 212) based on the clock switching signal 120 and assigns different clock signals (213, 214, 215) to the plurality of modulators (205, 206, 207) at different timings, and the pulse signal switch 204 that divides the pulse waveform setting signals (116, 117) into a plurality of amplitude signals (216, 217, 218) based on the pulse switching signal 115 and assigns the divided amplitude signals (216, 217, 218) to the plurality of modulators (205, 206, 207) at different timings, respectively.

The plurality of modulators (205, 206, 207) output a plurality of divided microwave pulses (219, 220, 221) based on the divided amplitude signals (216, 217, 218) and the clock signals (213, 214, 215). The adder 208 adds the divided microwave pulses (219, 220, 221) output from the plurality of modulators (205, 206, 207) together and outputs the single microwave pulse 111.

The plurality of modulators (205, 206, 207) sequentially output a plurality of pulses with different frequencies as the plurality of divided microwave pulses (219, 220, 221). The adder 208 outputs a frequency-multiplexed pulse as the single microwave pulse 111.

The clock switch 203 switches the clock signals (213, 214, 215) at the timing when the divided amplitude signals (216, 217, 218) are zero. The plurality of modulators (205, 206, 207) are configured as DACs (205, 206, 207) which are digital-to-analog converters.

As described above, the microwave pulse generator 101 according to Embodiment 1 includes a plurality of DACs (205, 206, 207) that operate at a high speed and switches the data signals (216, 217, 218) and the clock signals (213, 214, 215) input to the DACs (205, 206, 207), respectively. Therefore, the DACs (205, 206, 207) are turned on and off at a high speed to sequentially generate a plurality of pulses (219, 220, 221) with different frequencies in a short time, the pluses are added together to generate the multiplexed microwave signal 111, and the multiplexed microwave signal 111 is output.

The DACs (205, 206, 207) that switch the clock signals set the data signals (216, 217, 218) to 0 at the timing of the switching such that the outputs of the DACs (205, 206, 207) are turned off. This makes it possible to suppress the influence of the switching of the clock signals (213, 214, 215).

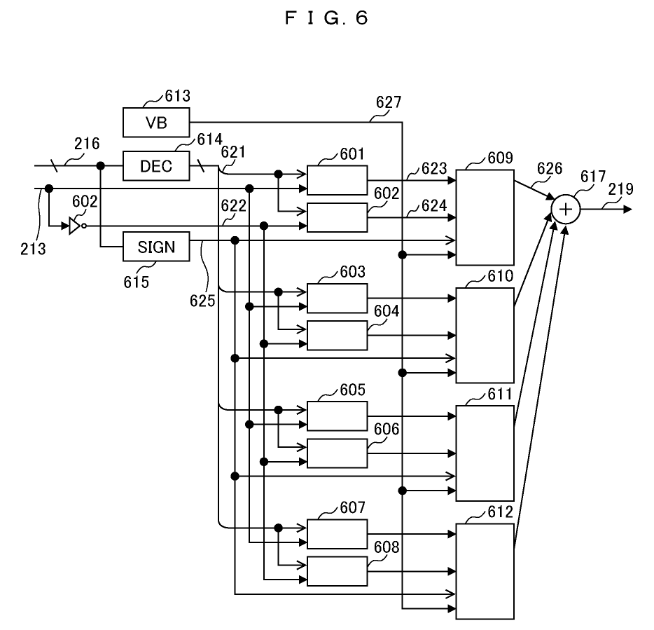

FIG. 6 shows an example of the high-frequency DAC_A 205, the high-frequency DAC_B 206, and the high-frequency DAC_C 207.

Since all of the high-frequency DAC_A 205, the high-frequency DAC_B 206, and the high-frequency DAC_C 207 use the same circuit, the high-frequency DAC_A 205 will be described as an example for convenience. In this example, signed 3-bit data is given as an example. However, even when the number of bits increases, only the number of parallel bits changes, and the principle remains the same. The high-frequency DAC_A 205 includes clock gate circuits 601, 602, 603, 604, 605, 606, 607, and 608, drive circuits 609, 610, 611, and 612, a voltage source 613, an ABS-equipped decoder 614, a sign determination circuit 615, an inverter 616, and an adder 617.

The inverter 616 is provided in order to clearly indicate a clock 622 obtained by inverting the high-frequency DAC_A clock 213 and is not necessary when the high-frequency DAC_A clock 213 is input as a differential signal. The ABS-equipped decoder 614 extracts an absolute value of the high-frequency DAC_A data 216 and decodes data of the absolute value. For example, in the case of signed 3-bit data, four values are output. The four output values are input to the clock gate circuits 601 and 602, the clock gate circuits 603 and 604, the clock gate circuits 605 and 606, and the clock gate circuits 607 and 608, respectively. Only when a decoder output 621 is at a high level, the clock gate circuits 601 and 602 pass the clock 213 and a clock 622 and output gated clocks 623 and 624, respectively. The other clock gate circuits 603, 604, 605, 606, 607, and 608 operate in the same manner.

The drive circuit 609 receives the gated clocks 623 and 624, outputs a positive pulse signal 626 when the sign data 625 is at the low level and the gated clock 623 is at the high level, and outputs a negative pulse signal 626 when the sign data 625 is at the low level and the gated clock 624 is at the high level. The drive circuit 609 outputs the negative pulse signal 626 when the sign data 625 is at the high level and the gated clock 623 is at the high level and outputs the positive pulse signal 626 when the sign data 625 is at the high level and the gated clock 624 is at the high level. Similarly, the drive circuits 610, 611, and 612 perform output according to the input clock. The adder 617 adds the outputs of the drive circuits 609, 610, 611, and 612 together and outputs a microwave pulse 219.

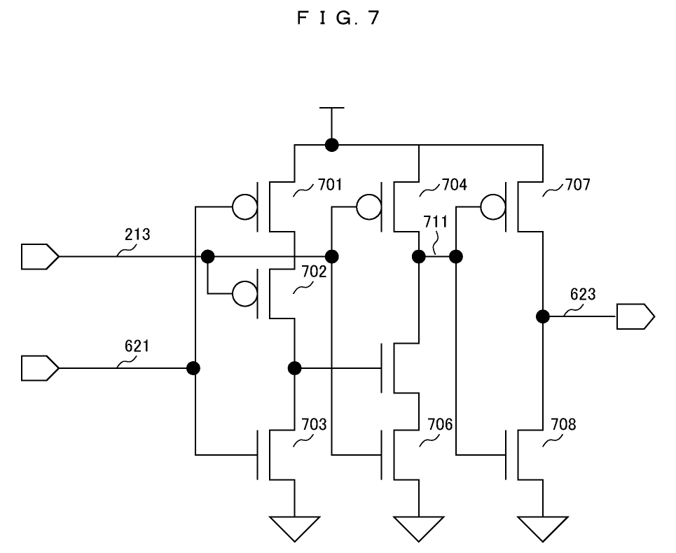

FIG. 7 shows an example of the clock gate circuits 601, 602, 603, 604, 605, 606, 607, and 608.

Since all of the clock gate circuits 601, 602, 603, 604, 605, 606, 607, and 608 are the same circuit, the clock gate circuit 601 is shown as a representative example. The clock gate circuit 601 includes PMOSs 701, 702, 704, and 707 and NMOSs 703, 705, 706, and 708. The PMOS 701, the PMOS 702, the NMOS 703, the PMOS 704, the NMOS 705, and the NMOS 706 form a domino-type circuit. In a case where the high-frequency DAC_A clock 213 changes from the low level to the high level only when the decoder output 621 is at the high level, a domino circuit output 711 changes from a high level to a low level. In the other cases, the domino circuit output 711 is at the high level. The PMOS 707 and the NMOS 708 form an inverter circuit, inverts the domino circuit output 711, and outputs the inverted signal. As described above, only when the decoder output 621 is at the high level, the clock gate circuit 601 passes the high-frequency DAC_A clock 213 and outputs the gated clock 623. When the decoder output 621 is at the low level, the gated clock 623 is changed to the low level.

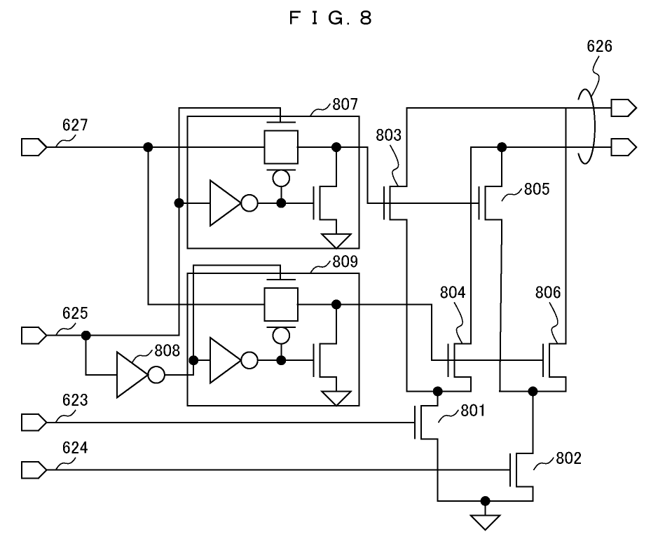

FIG. 8 shows an example of the drive circuits 609, 610, 611, and 612. Since all of the drive circuits 609, 610, 611, and 612 are the same circuit, the drive circuit 609 is shown as a representative example.

The drive circuit 609 includes NMOSs 801, 802, 803, 804, 805, and 806, a CMOS switch 807, an inverter 808, and a CMOS switch 809. In this example, a microwave pulse 626 is a differential current output. The NMOSs 801 and 802 have the role of current drivers and pull current when the clocks 623 and 624 are at the high level, respectively.

The NMOSs 803, 804, 805, and 806 have the role of cascodes. The NMOS 803 and the NMOS 804, and the NMOS 805 and the NMOS 806 operate complementarily, and a voltage is supplied to only one of the two NMOS transistors operating in a complementary manner to switch the source of the current pulled by the NMOS 801 and the NMOS 802. When the sign data 625 is at the high level, the CMOS switch 807 is turned on such that a bias voltage 627 is supplied to the NMOSs 803 and 805 and 0V is supplied to the NMOSs 804 and 806. When the sign data 625 is at the low level, a signal inverted by the inverter 808 is input to the CMOS switch 809, and the CMOS switch 809 is turned on such that the bias voltage 627 is supplied to the NMOSs 804 and 806 and 0V is supplied to the NMOSs 803 and 805.

### Embodiment 2

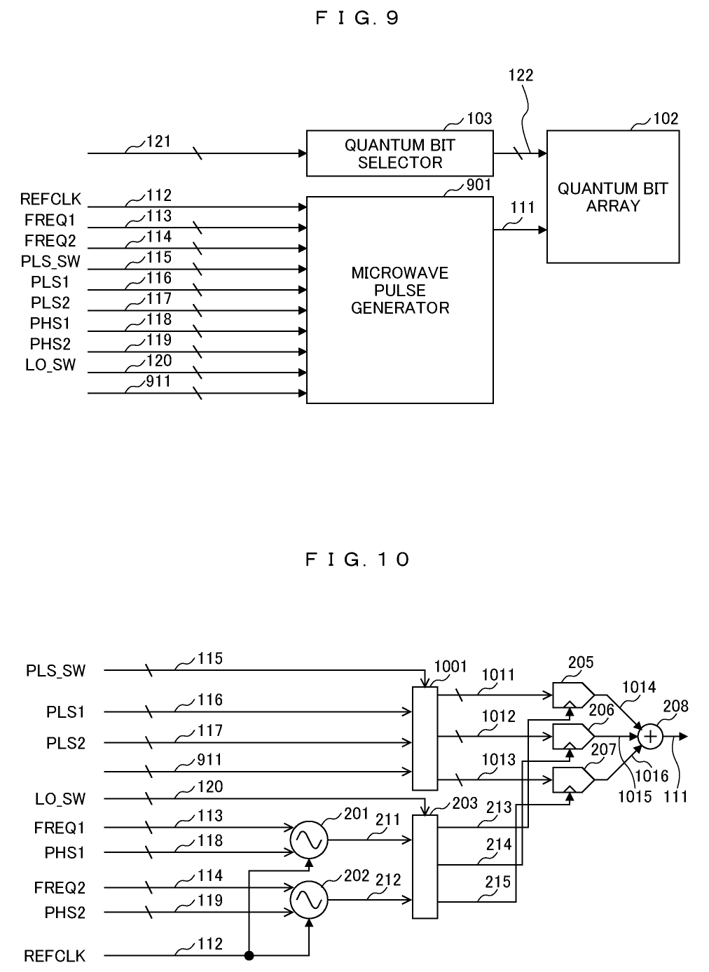

FIG. 9 shows peripheral connections of a microwave pulse generator 901 according to Embodiment 2 when the microwave pulse generator 901 is used. A pulse switching value limit 911 is added to the microwave pulse generator 901.

FIG. 10 shows the microwave pulse generator 901 according to Embodiment 2. A pulse signal switch 1001 is modified from that according to Embodiment 1, and a control method in which the pulse switching value limit 911 is input to gradually increase or decrease data when pulse data is switched is provided. Therefore, signals that are input to and output from the high-frequency DAC_A 205, the high-frequency DAC_B 206, and the high-frequency DAC_C 207 change.

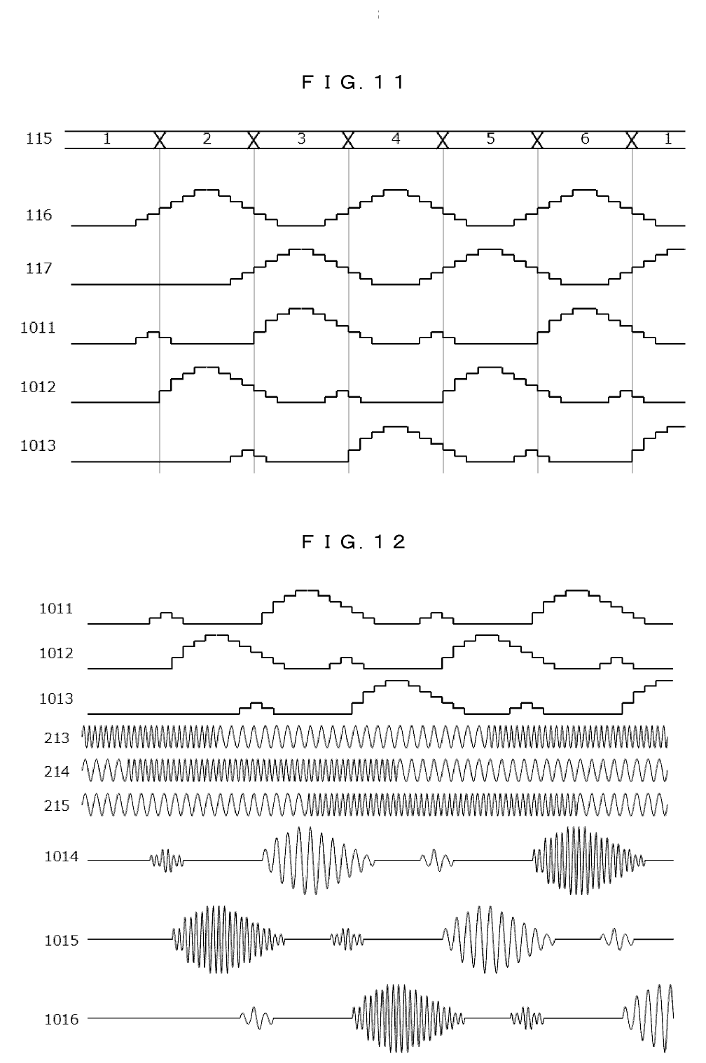

FIG. 11 shows the waveforms of signals input to and output from the pulse signal switch 1001 in the microwave pulse generator 901.

In the pulse signal switch 1001, when data is switched to another DAC, a control method is used that gradually increases or decreases the data instead of switching the data completely. FIG. 11 shows an example in which the pulse switching value limit 911 is set to 2, and the amounts of change in high-frequency DAC_A data 1011, high-frequency DAC_B data 1012, and high-frequency DAC_C data 1013 from 0 is limited to 2 or less. When the signal is increased and decreased gradually, the effect of preventing the circuit from being suddenly turned on and off and reducing fluctuations in power supply is expected.

FIG. 12 shows the input and output of the high-frequency DAC_A 205, the high-frequency DAC_B 206, and the high-frequency DAC_C 207 among the signal waveforms according to the embodiment shown in FIG. 10. The high-frequency DAC_A data 1011, the high-frequency DAC_B data 1012, and the high-frequency DAC_C data 1013 no longer rise sharply, and microwave pulses 1014, 1015, and 1016 also no longer rise sharply.

### Embodiment 3

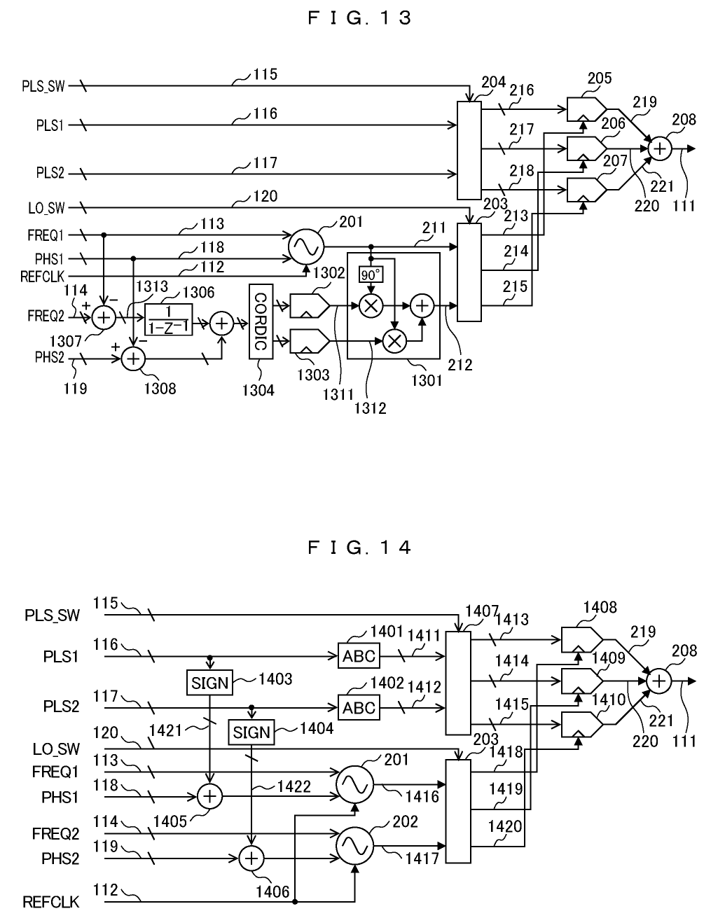

FIG. 13 shows Embodiment 3 of the microwave pulse generator 101. In Embodiment 3, the frequency generator A 201 and an IQ modulator 1301 are used instead of the frequency generator B to generate a clock 212 with a frequency different from that of the clock 211.

There is no need to use a frequency generator, such as a PLL, which is advantageous in terms of area and power consumption. In Embodiment 3, the frequency generator includes the IQ modulator 1301, a DAC 1302, a DAC 1303, a CORDIC 1304, an adder 1305, an integrator 1306, a subtractor 1307, and a subtractor 1308, instead of the frequency generator B202. The subtractor 1307 subtracts the frequency setting signal A 113 from the frequency setting signal B 114 and outputs an offset frequency 1313. The integrator 1306 integrates the offset frequency 1313 and outputs a phase offset. The subtractor 1308 subtracts the phase setting signal A 118 from the phase setting signal B 119 and outputs a phase difference. The adder 1305 adds the phase offset and the phase difference together and outputs phase data.

The CORDIC 1304 receives the phase data and outputs cosine data and sine data. The DAC 1302 receives the cosine data and outputs a cosine waveform 1311. The DAC 1303 receives the sine data and outputs a sine waveform 1312. The IQ modulator 1301 multiplies the cosine waveform 1311 and the sine waveform 1312 by the clock 211 and outputs the clock 212 with a frequency shifted from the frequency of the clock 211 by the offset frequency 1313. Since the offset frequency 1313 is obtained by subtracting the frequency setting signal A 113 from the frequency setting signal B 114, the frequency of the clock 212 is determined by the frequency setting signal B 114.

### Embodiment 4

FIG. 14 shows Embodiment 4 of the microwave pulse generator 101 using a method in which only the absolute value of the pulse waveform setting signal is input as data to the DAC and, when the pulse waveform setting signal is negative, an offset is applied to the phase of the phase setting signal.

In Embodiment 4, the microwave pulse generator 101 includes the frequency generator A 201, the frequency generator B 202, the clock switch 203, a pulse signal switch 1407, a high-frequency DAC_A 1408, a high-frequency DAC_B 1409, a high-frequency DAC_C 1410, the adder 208, an absolute value circuit 1401, an absolute value circuit 1402, a sign determination circuit 1403, a sign determination circuit 1404, an adder 1405, and an adder 1406.

The pulse waveform setting signal A 116 is input to the absolute value circuit 1401 and the sign determination circuit 1403, and the absolute value circuit 1401 calculates the absolute value of the pulse waveform setting signal A 116 and outputs a pulse waveform absolute value 1411. The sign determination circuit 1403 outputs a phase offset 1421 of 0 when the pulse waveform setting signal A 116 is positive and outputs a phase offset 1421 of 180° when the pulse waveform setting signal A 116 is negative. The pulse waveform setting signal B 117 is input to the absolute value circuit 1402 and the sign determination circuit 1404, and the absolute value circuit 1402 calculates the absolute value of the pulse waveform setting signal B 117 and outputs a pulse waveform absolute value 1412. The sign determination circuit 1404 outputs a phase offset 1422 of 0 when the pulse waveform setting signal B 117 is positive and outputs a phase offset 1422 of 180° when the pulse waveform setting signal B 117 is negative.

The phase setting signal A 118 and the phase offset 1421 are input to the adder 1405 and are added together, and the result of the phase addition is input to the frequency generator A 201. The phase setting signal B 119 and the phase offset 1422 are input to the adder 1406 and are added together, and the result of the phase addition is input to the frequency generator B 202. The frequency generator A 201 multiplies the result of the phase addition by the reference clock 112 and outputs a clock 1416 that has the frequency set by the frequency setting signal A 113 and the phase set by the output of the adder 1405.

The frequency generator B 202 multiplies the result of the phase addition by the reference clock 112 and outputs a clock 1417 that has the frequency set by the frequency setting signal B 114 and the phase set by the output of the adder 1406. The pulse signal switch 1407 determines which of high-frequency DAC_A data 1413, high-frequency DAC_B data 1414, and high-frequency DAC_C data 1415 the input pulse waveform absolute values 1411 and 1412 are output to, according to the pulse switching signal 115. The clock switch 203 determines which of a high-frequency DAC_A clock 1418, a high-frequency DAC_B clock 1419, and a high-frequency DAC_C clock 1420 the input clocks 1416 and 1417 are output to, according to the clock switching signal 120. The high-frequency DAC_A 1408 receives the high-frequency DAC_A clock 1418 and the high-frequency DAC_A data 1413 and outputs the microwave pulse 219 that has the high-frequency DAC_A data 1413 as an amplitude and the frequency of the high-frequency DAC_A clock 1418 as a center frequency.

Similarly, the high-frequency DAC_B 1409 receives the high-frequency DAC_B clock 1419 and the high-frequency DAC_B data 1414 and outputs the microwave pulse 220 that has the high-frequency DAC_B data 1414 as an amplitude and the frequency of the high-frequency DAC_B clock 1419 as a center frequency. Similarly, the high-frequency DAC_C 1410 receives the high-frequency DAC_C clock 1420 and the high-frequency DAC_C data 1415 and outputs the microwave pulse 221 that has the high-frequency DAC_C data 1415 as an amplitude and the frequency of the high-frequency DAC_C clock 1420 as a center frequency. The adder 208 adds the microwave pulse 219, the microwave pulse 220, and the microwave pulse 221 together to generate the microwave pulse 111.

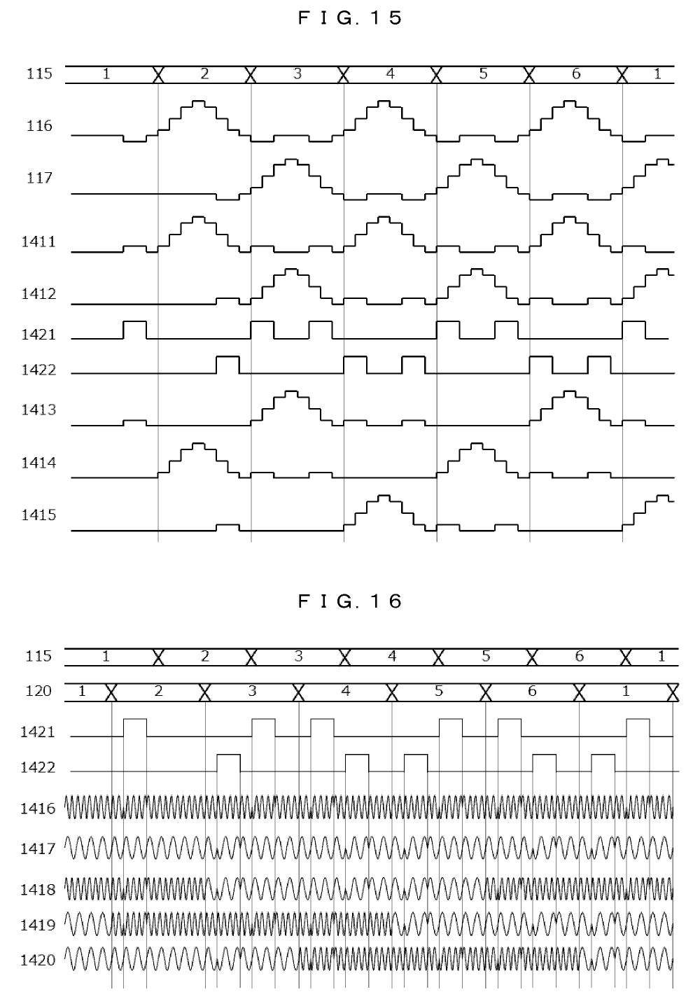

FIG. 15 shows the input and output of the pulse signal switch 1407, the pulse waveform setting signal A 116, and the pulse waveform setting signal B 117 among the signal waveforms according to the embodiment shown in FIG. 14.

The pulse waveform setting signal A 116 is converted into the pulse waveform absolute value 1411, which is the absolute value of the pulse waveform setting signal A 116, and the phase offset 1421. The pulse waveform setting signal B 116 is converted into the pulse waveform absolute value 1412, which is the absolute value of the pulse waveform setting signal B 117, and the phase offset 1422. In the example shown in FIG. 15, when the pulse switching signal 115 is 1, the pulse waveform setting signal A 1411 is output to the high-frequency DAC_A data 1413, 0 is output to the high-frequency DAC_B data 1414, and the pulse waveform setting signal B 1412 is output to the high-frequency DAC_C data 1415.

When the pulse switching signal 115 is 2, 0 is output to the high-frequency DAC_A data 1413, the pulse waveform setting signal A 1411 is output to the high-frequency DAC_B data 1414, and the pulse waveform setting signal B 1412 is output to the high-frequency DAC_C data 1415. When the pulse switching signal 115 is 3, the pulse waveform setting signal B 1412 is output to the high-frequency DAC_A data 1413, the pulse waveform setting signal A 1411 is output to the high-frequency DAC_B data 1414, and 0 is output to the high-frequency DAC_C data 1415.

When the pulse switching signal 115 is 4, the pulse waveform setting signal B 1412 is output to the high-frequency DAC_A data 1413, 0 is output to the high-frequency DAC_B data 1414, and the pulse waveform setting signal A 1411 is output to the high-frequency DAC_C data 1415. When the pulse switching signal 115 is 5, 0 is output to the high-frequency DAC_A data 1413, the pulse waveform setting signal B 1412 is output to the high-frequency DAC_B data 1414, and the pulse waveform setting signal A 1411 is output to the high-frequency DAC_C data 1415.

When the pulse switching signal 115 is 6, the pulse waveform setting signal A 1411 is output to the high-frequency DAC_A data 1413, the pulse waveform setting signal B 1412 is output to the high-frequency DAC_B data 1414, and 0 is output to the high-frequency DAC_C data 1415. As described above, of the pulse waveform setting signal A 1411 and the pulse waveform setting signal B 1412, the same signal is output to each of the high-frequency DAC_A data 1413, the high-frequency DAC_B data 1414, and the high-frequency DAC_C data 1415 twice, and then 0 is output. Then, the pulse waveform setting signal is switched to the other signal.

FIG. 16 shows the input and output of the clock switch 203 among the signal waveforms according to the embodiment shown in FIG. 14.

When the pulse waveform is negative, a phase offset of 180° is applied to the clock 1416 and the clock 1417 by the phase offset 1421 and the phase offset 1422, respectively. The clock switching signal 120 is switched during the period when the pulse switching signal 115 is constant, and the clock to be input to the DAC to which data input is 0 among the high-frequency DAC_A 1408, the high-frequency DAC_B 1409, and the high-frequency DAC_C 1410 is switched. Since degradation of clock characteristics, such as a reduction in amplitude, is considered during switching, clock switching is performed on the DAC to which the input data is 0 and which outputs 0. In this way, when the clock switching signal 120 is 1, the clock 1416 is output to the high-frequency DAC_A clock 1418, the clock 1417 is output to the high-frequency DAC_B clock 1419, and the clock 1417 is output to the high-frequency DAC_C clock 1420.

Similarly, when the clock switching signal 120 is 2, the clock 1416 is output to the high-frequency DAC_A clock 1418, the clock 1416 is output to the high-frequency DAC_B clock 1419, and the clock 1417 is output to the high-frequency DAC_C clock 1420. When the clock switching signal 120 is 3, the clock 1417 is output to the high-frequency DAC_A clock 1418, the clock 1416 is output to the high-frequency DAC_B clock 1419, and the clock 1417 is output to the high-frequency DAC_C clock 1420. When the clock switching signal 120 is 4, the clock 1417 is output to the high-frequency DAC_A clock 1418, the clock 1416 is output to the high-frequency DAC_B clock 1419, and the clock 1416 is output to the high-frequency DAC_C clock 1420.

When the clock switching signal 120 is 5, the clock 1417 is output to the high-frequency DAC_A clock 1418, the clock 1417 is output to the high-frequency DAC_B clock 1419, and the clock 1416 is output to the high-frequency DAC_C clock 1420. When the clock switching signal 120 is 6, the clock 1416 is output to the high-frequency DAC_A clock 1418, the clock 1417 is output to the high-frequency DAC_B clock 1419, and the clock 1417 is output to the high-frequency DAC_C clock 1420.

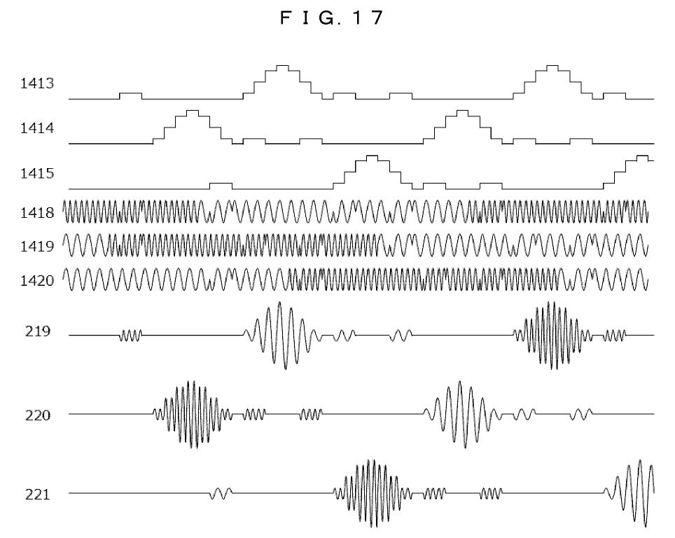

FIG. 17 shows the input and output of the high-frequency DAC_A 1408, the high-frequency DAC_B 1409, and the high-frequency DAC_C 1410 among the signal waveforms according to the embodiment shown in FIG. 14.

The high-frequency DAC_A 1408 generates the microwave pulse 219 that has the high-frequency DAC_A data 1413 as an envelope and has the same frequency as the high-frequency DAC_A clock 1418. The high-frequency DAC_B 1409 generates the microwave pulse 220 that has the high-frequency DAC_B data 1414 as an envelope and has the same frequency as the high-frequency DAC_B clock 1419. The high-frequency DAC_C 1410 generates the microwave pulse 221 that has the high-frequency DAC_C data 1415 as an envelope and has the same frequency as the high-frequency DAC_C clock 1420.

The high-frequency DAC_A data 1413, the high-frequency DAC_B data 1414, the high-frequency DAC_C data 1415, the high-frequency DAC_A clock 1418, the high-frequency DAC_B clock 1419, and the high-frequency DAC_C clock 1420 are switched over time, resulting in changes in the microwave pulse 219, the microwave pulse 220, and the microwave pulse 221. The microwave pulse 111, which is the output of the microwave pulse generator 101, has the waveform obtained by adding the microwave pulse 219, the microwave pulse 220, and the microwave pulse 221 together using the adder 208.

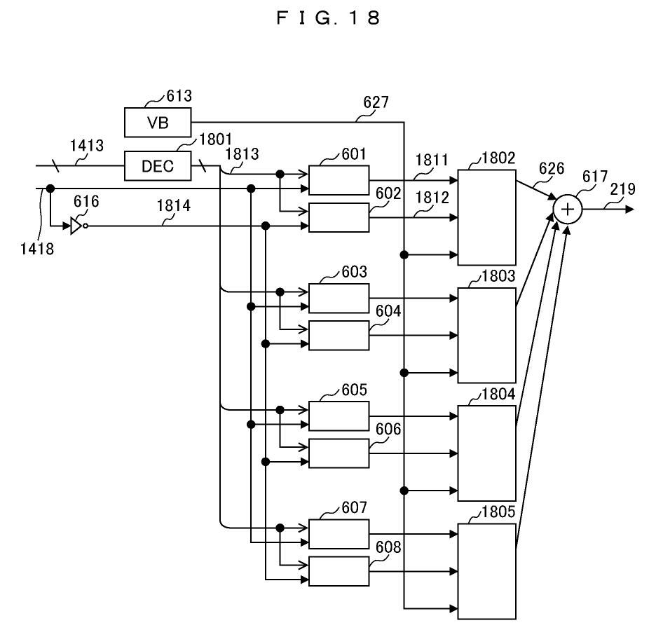

FIG. 18 shows an example of the high-frequency DAC_A 1408, the high-frequency DAC_B 1409, and the high-frequency DAC_C 1410. Since all of the high-frequency DAC_A 1408, the high-frequency DAC_B 1409, and the high-frequency DAC_C 1410 use the same circuit, the high-frequency DAC_A 1408 is given as an example for convenience. In this example, 2-bit data is given as an example. However, even when the number of bits increases, only the number of parallel bits changes, and the principle remains the same.

The configuration is different from that shown in FIG. 6 in that the code determination circuit 614 is not provided, a decoder 1801 replaces the ABS-equipped decoder 614, and drive circuits 1802, 1803, 1804, and 1805 replace the drive circuits 609, 610, 611, and 612, respectively. The high-frequency DAC_A 1408 includes the clock gate circuits 601, 602, 603, 604, 605, 606, 607, and 608, the drive circuits 1802, 1803, 1804, and 1805, the voltage source 613, the decoder 1801, the inverter 616, and the adder 617. The inverter 616 is provided in order to clearly indicate a clock 1814 obtained by inverting the high-frequency DAC_A clock 1418 and is not necessary when the high-frequency DAC_A clock 1418 is input as a differential signal.

The decoder 1801 outputs a decoder output 1813 obtained by decoding the high-frequency DAC_A data 1413. For example, in the case of 2-bit data, four values are output. The four output values are input to the clock gate circuits 601 and 602, the clock gate circuits 603 and 604, the clock gate circuits 605 and 606, and the clock gate circuits 607 and 608, respectively. Only when the decoder output 1813 is at a high level, the clock gate circuits 601 and 602 pass the clock 1418 and the clock 1814 and output gated clocks 1811 and 1812, respectively.

The other clock gate circuits 603, 604, 605, 606, 607, and 608 operate in the same manner. The drive circuit 1802 receives the gated clocks 1811 and 1812, outputs a positive pulse signal 626 when the gated clock 1811 is at a high level, and outputs a negative pulse signal 626 when the gated clock 1812 is at a high level. Similarly, the drive circuits 1803, 1804, and 1805 perform output according to the input clock. The adder 617 adds the outputs of the drive circuits 1802, 1803, 1804, and 1805 together and output the microwave pulse 219.

FIG. 19 shows an example of the drive circuits 1802, 1803, 1804, and 1805. Since all of the drive circuits 1802, 1803, 1804, and 1805 are the same circuit, the drive circuit 1802 is shown as a representative example. The drive circuit 1802 includes NMOSs 1901, 1902, 1903, and 1904. In this example, the microwave pulse 626 is output as a differential current. The NMOSs 1901 and 1902 have the role of current drivers and pull a current when the clocks 1811 and 1812 are at the high level, respectively. The NMOSs 1903 and 1904 have the role of cascodes and are supplied with the bias voltage 627.

### Embodiment 5

In Embodiment 5, how a quantum device is used in the overall system will be described.

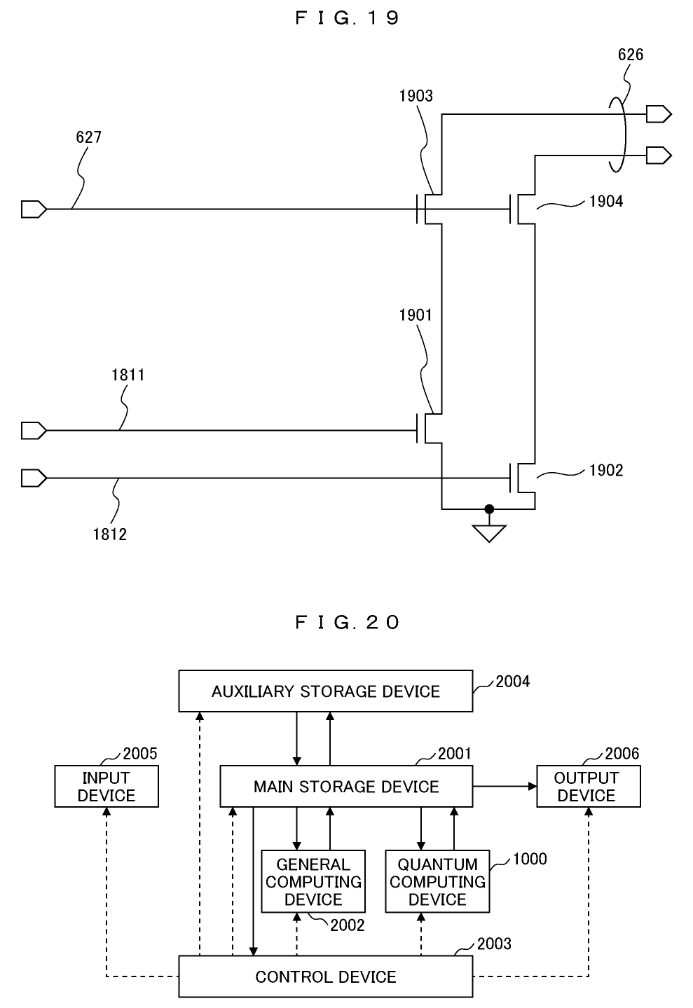

FIG. 20 shows an example of the configuration of a computer according to this embodiment. The configuration of the computer shown in FIG. 20 is similar to the configuration of a general computer but is characterized by including a quantum computing device 1000. The quantum computing device 1000 is a quantum computing device including the quantum bit array 102 (see FIG. 1). The other general computations are performed by a general computing device 2002.

The above configuration may be configured as an integrated computer or another computer in which any portions, such as a main storage device 2001, the general computing device 2002, a control device 2003, an auxiliary storage device 2004, an input device 2005, and an output device 2006, are connected via a network.

General computations are performed in the same procedure as those of the general computer. Data is exchanged between the main storage device 2001, which is a storage unit, and the general computing device 2002, which is a computing unit, and computations are carried out by repeating the data exchange. At that time, the control device 2003 controls the overall operation. Programs executed by the general computing device 2002 are stored in the main storage device 2001 which is the storage unit. When the storage capacity of the main storage device 2001 is insufficient, the auxiliary storage device 2004, which is also a storage unit, is used. The input device 2005 is used to input data, programs, and the like, and the output device 2006 is used to output the results. The input device 2005 includes an interface for network connection, in addition to a manual input device such as a keyboard. Further, the interface also serves as the output device.

Quantum computations are performed in the same manner. Data is exchanged between the main storage device 2001, which is the storage unit, and the quantum computing device 1000, which is the computing unit, and computations are carried out by repeating the data exchange. At that time, the control device 2003 controls the overall operation. Programs executed by the quantum computing device 1000 are stored in the main storage device 2001 which is the storage unit.

The program is converted into a language used by the quantum computing device 1000 by the general computing device 2002 and stored in the main storage device 2001. When the storage capacity of the main storage device 2001 is insufficient, the auxiliary storage device 2004, which is also the storage unit, is used. The program converted into the language is transmitted from the main storage device 2001 to the quantum computing device 1000, and the control device 2003 transmits a control signal to the quantum computing device 1000 according to the program converted into the language to execute computations. The execution results of the quantum computing device 1000 are transmitted to the main storage device 2001 and are post-processed by the general computing device 2002 as necessary.

In the above-described embodiments, a plurality of DACs that operate at a high speed are provided, and the data signal and the clock signal input to each DAC are switched to turn on and off the output circuit at a high speed, thereby sequentially generating a large number of pulses with different frequencies in a short time. The DAC that switches the clock signal sets the data signal to 0 at the timing of switching to turn off the output. Therefore, the influence of the switching of the clock signal is suppressed.

According to the above-described embodiments, in the quantum computer using electron spin, the microwave pulse generator that performs quantum operations can achieve both the ON/OFF control of the output circuit on the order of nanoseconds and the maximization of the number of quantum bit operations within the operation time. It is possible to turn on and off the circuit at a high speed and to output the maximum number of microwave pulses within the operating time. Therefore, it is possible to turn on and off the circuit at a high speed, to suppress unnecessary noise during a period other than a control period, and to operate the maximum number of quantum bits within a predetermined period of time.

100: quantum computer

101: microwave pulse generator

102: quantum bit array

103: quantum bit selector

111: microwave pulse

112: reference clock

113: frequency setting signal A

114: frequency setting signal B

115: pulse switching signal

116: pulse waveform setting signal A

117: pulse waveform setting signal B

118: phase setting signal A

119: phase setting signal B

120: clock switching signal

121: quantum bit address signal

122: quantum bit selection signal

201: frequency generator A

202: frequency generator B

203: clock switch

204: pulse signal switch

205: high-frequency DAC_A

206: high-frequency DAC_B

207: high-frequency DAC_C

208: adder

211: clock

212: clock

213: high-frequency DAC_A clock

214: high-frequency DAC_B clock

215: high-frequency DAC_C clock

216: high-frequency DAC_A data

217: high-frequency DAC_B data

218: high-frequency DAC_C data

219: microwave pulse

220: microwave pulse

221: microwave pulse

601: clock gate circuit

602: clock gate circuit

603: clock gate circuit

604: clock gate circuit

605: clock gate circuit

606: clock gate circuit

607: clock gate circuit

608: clock gate circuit

609: drive circuit

610: drive circuit

611: drive circuit

612: drive circuit

613: voltage source

614: ABS-equipped decoder

615: sign determination circuit

616: inverter circuit

617: adder

621: decoder output

622: clock

623: gated Clock

624: gated Clock

625: sign data

626: pulse signal

627: bias voltage

701: PMOS

702: PMOS

703: NMOS

704: PMOS

705: NMOS

706: NMOS

707: PMOS

708: NMOS

711: domino circuit output

901: microwave pulse generator

911: pulse switching value limit

1001: pulse signal switch

1011: high-frequency DAC_A data

1012: high-frequency DAC_B data

1013: high-frequency DAC_C data

1014: microwave pulse

1015: microwave pulse

1016: microwave pulse

1301: IQ modulator

1302: DAC

1303: DAC

1304: CORDIC

1305: adder

1306: integrator

1307: subtractor

1308: subtractor

1311: cosine waveform

1312: sine waveform

1313: offset frequency

1401: absolute value circuit

1402: absolute value circuit

1403: sign determination circuit

1404: sign determination circuit

1405: adder

1406: adder

1407: pulse signal switch

1408: high-frequency DAC_A

1409: high-frequency DAC_B

1410: high-frequency DAC_C

1411: pulse waveform absolute value

1412: pulse waveform absolute value

1413: high-frequency DAC_A data

1414: high-frequency DAC_B data

1415: high-frequency DAC_C data

1416: clock

1417: clock

1418: high-frequency DAC_A clock

1419: high-frequency DAC_B clock

1420: high-frequency DAC_C clock

1421: phase offset

1422: phase offset

1801: decoder

1802: drive circuit

1803: drive circuit

1804: drive circuit

1805: drive circuit

1811: gated clock

1812: gated clock

1813: decoder output

1814: clock

What is claimed is:

1. A microwave pulse generator comprising:
a plurality of modulators;
an adder adding output signals of the plurality of modulators;
an oscillator generating a plurality of clock signals with different frequencies;
a clock switch that switches between the plurality of clock signals based on a clock switching signal and assigns different clock signals to the plurality of modulators at different timings; and
a pulse signal switch that divides a pulse waveform setting signal into a plurality of amplitude signals based on a pulse switching signal and assigns the divided amplitude signals to the plurality of modulators at different timings, respectively,
wherein the plurality of modulators output a plurality of divided microwave pulses based on the divided amplitude signals and the clock signals, and
the adder adds the divided microwave pulses output from the plurality of modulators and outputs a single microwave pulse.

2. The microwave pulse generator according to claim 1,
wherein the plurality of modulators sequentially output a plurality of pulses with different frequencies as the plurality of divided microwave pulses, and
the adder outputs a pulse in which the frequencies have been multiplied as the single microwave pulse.

3. The microwave pulse generator according to claim 1,
wherein the clock switch switches the clock signal at a timing when the divided amplitude signal is 0.

4. The microwave pulse generator according to claim 1,
wherein the modulator is configured as a digital-to-analog converter.

5. The microwave pulse generator according to claim 1,
wherein a threshold value for a set amount of change is input, and
the divided amplitude signal changes at or below the threshold value at a switching timing.

6. The microwave pulse generator according to claim 5,
wherein the pulse signal switch receives a pulse switching value limiting signal having the threshold value for the amount of change and prevents the divided amplitude signal from changing suddenly at the switching timing, based on the pulse switching value limiting signal.

7. The microwave pulse generator according to claim 1,
wherein the oscillator includes a plurality of frequency generators.

8. The microwave pulse generator according to claim 7,
wherein an absolute value component and a sign component are separated from each of the plurality of divided amplitude signals, a phase offset is applied based on the sign component, and a clock signal to which the phase offset has been applied and the absolute value component are input to the plurality of frequency generators.

9. The microwave pulse generator according to claim 1,
wherein the oscillator includes a frequency generator and an IQ modulator, and
the IQ modulator receives a cosine wave and a sine wave, to which an offset frequency and a phase offset with respect to the frequency generator have been applied, and an output from the frequency generator and multiplies the sine and cosine waves and the output to generate a clock signal whose frequency and phase have been shifted by the offset frequency and the phase offset with respect to the frequency generator.

10. The microwave pulse generator according to claim 1,
wherein the microwave pulse generator is disposed in a quantum computer performing quantum computation.

11. A quantum computer comprising:
a quantum bit array storing information; and
a microwave pulse generator operating the quantum bit array,
wherein the microwave pulse generator includes
a plurality of modulators,
an adder adding output signals of the plurality of modulators,
an oscillator generating a plurality of clock signals with different frequencies,
a clock switch that switches between the plurality of clock signals based on a clock switching signal and assigns different clock signals to the plurality of modulators at different timings, and
a pulse signal switch that divides a pulse waveform setting signal into a plurality of amplitude signals based on a pulse switching signal and assigns the divided amplitude signals to the plurality of modulators at different timings, respectively,
the plurality of modulators output a plurality of divided microwave pulses based on the divided amplitude signals and the clock signals, and
the adder adds the divided microwave pulses output from the plurality of modulators and outputs a single microwave pulse.

12. The quantum computer according to claim 11, further comprising:
a quantum bit selector outputting a quantum bit selection signal,
wherein the quantum bit array has quantum bits disposed in an array,
the quantum bit selector selects the quantum bit to be operated from the quantum bit array, and
a state of the quantum bit selected by the quantum bit selection signal is operated by irradiation with the single microwave pulse obtained by adding together the divided microwave pulses.

13. A microwave pulse generation method for generating a microwave pulse using a plurality of modulators, comprising:
a first step of generating a plurality of clock signals with different frequencies;
a second step of switching between the plurality of clock signals based on a clock switching signal and assigning different clock signals to the plurality of modulators at different timings;
a third step of dividing a pulse waveform setting signal into a plurality of amplitude signals based on a pulse switching signal and assigning the divided amplitude signals to the plurality of modulators at different timings, respectively;
a fourth step of outputting a plurality of divided microwave pulses based on the divided amplitude signals and the clock signals; and
a fifth step of adding the divided microwave pulses output from the plurality of modulators and outputting a single microwave pulse.

14. The microwave pulse generation method according to claim 13,
wherein the microwave pulse is generated using a quantum computer performing quantum computation.
